(19) United States
(12) Patent Application Publication
(10) Pub. No.: US 2010/0271610 A1
(43) Pub. Date: Oct. 28, 2010

(54) LITHOGRAPHIC RADIATION SOURCE, COLLECTOR, APPARATUS AND METHOD

(75) Inventors: Wouter Anthon SOER, Nijmegen (NL); Martin Jacobus Johan Jak, Eindhoven (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 12/764,535

(22) Filed: Apr. 21, 2010

Related U.S. Application Data
(60) Provisional application No. 61/171,627, filed on Apr. 22, 2009.

(51) Int. Cl. G03B 27/54; H05G 2/00; G02B 13/14

(52) U.S. Cl. 355/67; 250/504 R; 359/359; 359/350

(57) ABSTRACT

A collector assembly for use in a laser-produced plasma extreme ultraviolet radiation source for use in lithography has a collector body having a collector mirror and a window in the collector body. The window is transmissive to excitation radiation, which may be an infrared laser beam, so that it can pass through the window to excite the plasma, and the window has an EUV minor on its surface which is also transmissive to the excitation beam but which can reflect EUV generated by the plasma to the collector location of the collector mirror. The window may improve the collection efficiency and reduce non-uniformity in the image at the collector location. Radiation sources, lithographic apparatus and device manufacturing methods may make use of the collector.

### CROSS-REFERENCE TO RELATED APPLICATIONS

This application claims the benefit of priority from U.S. Provisional Patent Application No. 61/171,627, filed on Apr. 22, 2009, the content of which is incorporated herein by reference in its entirety.

### FIELD

The present invention relates to lithographic apparatus and in particular to radiation sources and collector assemblies for providing conditioned radiation, such as extreme ultra-violet radiation (EUV). The invention is suitable for use in manufacturing devices, integrated circuits, integrated optical systems, guidance and detection patterns for magnetic domain memories, flat-panel displays, liquid-crystal displays (LCDs), thin-film magnetic heads, and the like, by lithography, particularly high resolution lithography.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

CD=k₁λ/NA_{PH} (1)

where λ is the wavelength of the radiation used, NA_{PS} is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength k, by increasing the numerical aperture NA_{PS} or by decreasing the value of k₁.

In order to shorten the exposure wavelength and, thus, reduce the minimum printable size, it has been proposed to use an extreme ultraviolet (EUV) radiation source. EUV radiation sources are configured to output a radiation wavelength of from 2 to 15 nm, typically about 13 nm. Thus, EUV radiation sources may constitute a significant step toward achieving printing of small features. Such radiation is termed extreme ultraviolet or soft x-ray, and possible sources include, for example, laser-produced plasma sources, discharge plasma sources, or synchrotron radiation from electron storage rings.

Actinic radiation such as extreme ultraviolet radiation and beyond EUV radiation may for instance be produced using a discharge produced plasma (DPP) radiation generator. A plasma is created by, for example, passing an electrical discharge through a suitable material (e.g. a gas or vapour). The resulting plasma may be compressed (i.e. be subjected to a pinch effect), typically by means of a laser at which point electrical energy is converted into electromagnetic radiation in the form of extreme ultraviolet radiation (or beyond EUV radiation). Various devices are known in the art to generate EUV radiation.

Another EUV radiation generator is a laser produced plasma (LPP) source. The plasma may be created in a chamber for example by directing a beam of excitation radiation, such as a laser beam, typically an infrared laser beam, at particles of a suitable fuel material (e.g. tin, lithium or xenon), or by directing a laser at a stream of a suitable gas (e.g. Sn vapor, SnH₄, or a mixture of Sn vapor and any gas with a small nuclear charge (for example from H₂ up to Ar)). The resulting plasma emits extreme ultraviolet radiation (or beyond EUV radiation).

The target stream is radiated by high-power laser beam pulses, typically from, for instance, an Nd:YAG or a CO₂ laser, the pulses heating the target fuel material to produce a high temperature plasma which emits the EUV radiation. The frequency of the laser beam pulses is application specific and depends upon a variety of factors. The laser beam pulses require adequate intensity in the target area (i.e. plasma formation site) in order to provide enough heat to generate the plasma.

### SUMMARY

EUV radiation emitted from the plasma formation site of a radiation source for lithography is typically collected using a collector arranged to direct the EUV radiation to a collector location (also termed a collector focus) from where it continues on for use in a lithography process or apparatus. The EUV radiation leaves a chamber of the radiation source through an exit aperture. A conventional prior art collector may, for instance, have a mirrored face of ellipsoidal shape, with the plasma formation site at one (first) focal point of the ellipsoid such that the EUV radiation falls onto the mirror at substantially normal incidence angle and is formed into a beam passing out of the chamber at the exit aperture and focused onto another (second) focal point of the ellipsoid, the so-called intermediate focus, which acts as the collection location.

Typically, for instance, when the radiation source includes a LPP source of EUV radiation, the collector may be provided with an aperture passing therethrough to permit the laser beam used in generating the EUV radiation at the plasma formation site to enter the chamber of the radiation source such that the laser beam may be focused onto the plasma formation site. EUV emission from a plasma formation site is highest on the side of the fuel source upon which the excitation laser is incident, particularly when the fuel source is not fully excited. Hence, is preferable to excite the LPP fuel source from the same side as the collector mirror, so that the most intense EUV radiation generated by the plasma is collected. One problem with this arrangement is that the aperture in the collector used to allow the laser beam to be focussed on the plasma fuel supply also results in an aperture being present in the collector mirror. Hence, EUV radiation falling on this aperture in the collector mirror and collector aperture passes out of the chamber through the collector aperture instead of being collected and reflected towards the collection location.

This may present a strong non-uniformity in the far-field image of the EUV radiation, making the image annular, rather than circular, in shape. In general, strong non-uniformities in the EUV image are not desirable since they must be compensated for in an illuminator illuminator forming the next stage of the optical system of the lithography apparatus. Such compensation may result in optical losses in the illuminator, for example because additional mirrors are needed leading to further reflective losses.

Furthermore, the collection efficiency is reduced because EUV radiation falling on the aperture is lost from the chamber rather than collected and reflected towards the collection location.

Typically, the reflective surfaces of the mirrors used in the photolithography optical system are coated with a reflective coating to enhance their reflectance for EUV radiation. It may also be desirable for the reflective coating material not to degrade in response to high energy ions generated, for instance, by plasma that may impinge upon the reflective surface and release the reflective coating material. A suitable coating for use with plasma radiation generators is a silicon/molybdenum (Si/Mo) multilayer. The Si/Mo coating on the collector optics will typically only reflect about 70% of the EUV radiation impinging thereon, even at its theoretical maximum performance. Also, the reflective efficiency of such multilayer coatings is highly dependent upon the angle of incidence of radiation.

It is desirable to have as much of the radiation as possible collected and directed to the collection location in order to improve the efficiency of the collector assembly and to provide more effective radiation sources for use in lithography. For instance, the higher the intensity of the radiation for a particular photolithography process, the less time will be needed to properly expose the various photoresists that may be being exposed for providing patterning. Reduction in the exposure time means that more circuits, devices, etc. can be fabricated, increasing throughput efficiency and decreasing manufacturing costs.

Also, the excitation power used to produce radiation may be reduced, thus conserving the input energy required and potentially extending the life of the excitation source. It is also desirable to improve efficiency of collection for the EUV radiation and to increase the radiation collected for the illuminator of a lithography apparatus without increasing the etendue (acceptance angle) of the illuminator.

Furthermore, the laser beam is desirably focused on the fuel at the plasma formation site such that the excitation image of the laser beam impacting the fuel is as small as possible. This is in order to achieve as high a power density as possible. However, the size of the excitation image is limited by diffraction, due to the relatively large wavelength of the laser beam (for instance 10.6 μm for a CO₂ laser). Therefore, it is desirable to use a large numerical aperture for the focusing optics of the laser beam.

Because of these reasons, the laser beam is commonly focused onto the droplet through a large central aperture in the collector. However, increasing the size of the aperture in the collector and hence in the collector mirror, leads to a reduction in the solid angle over which EUV radiation is collected, which may lead to loss in the source image uniformity and loss in collection efficiency.

It is one aim, amongst others, of the present invention, to address the above-mentioned problems. The invention may also address other problems in the prior art.

One aspect of the invention provides a collector assembly for an extreme ultraviolet radiation source comprising an excitation radiation source arranged to generate extreme ultraviolet radiation from a fuel at a plasma formation site. The collector assembly includes a collector body having a first surface and a second surface, opposed to the first surface and provided with a collector mirror thereon, the collector mirror configured to collect and reflect said extreme ultraviolet radiation from a first focus of the collector mirror at said plasma formation site and to direct said extreme ultraviolet radiation to a collection location, wherein the collector assembly comprises a window transmissive to excitation radiation and having a first face and an opposed second face, the second face facing towards the first focus, wherein the second face of the window comprises a window mirror thereon, configured to collect and reflect said extreme ultraviolet radiation from the first focus of the collector mirror at said plasma formation site and to direct said extreme ultraviolet radiation to the collection location, and wherein the window mirror is constructed and arranged to be reflective to said extreme ultraviolet radiation and to be transmissive to said excitation radiation.

Suitably, the excitation radiation is infra-red radiation. Typically, the excitation radiation source is a laser, such as a Nd:YAG (neodymium-doped yttrium aluminium garnet) laser or a CO₂ laser.

For an infrared excitation source, the window is suitable of a material transmissive to infrared radiation, selected from the group consisting of group IV semiconductors, III-V semiconductors and II-VI semiconductors, preferably from group consisting of gallium arsenide, zinc selenide and silicon.

The first face of the window may comprise a first antireflective coating thereon, constructed and arranged to reduce reflection of the infrared excitation beam on passage through the first face. When the excitation radiation is infrared radiation, for instance, the first antireflective coating may comprise or be of a ThF₄ layer. The first antireflective coating may suitably comprise a ZnSe layer between the ThF₄ layer and the first face of the window.

The second face of the window may comprise a second antireflective coating, constructed and arranged to reduce reflection of the excitation radiation on passage through the second face of the window. The second antireflective coating may be located between the second face and the window mirror. The second antireflective coating may comprise or be a ThF₄ layer, particularly when the excitation radiation is infrared radiation.

The window mirror may comprise alternating layers of diamond-like carbon and silicon.

The collector body and the window may both be formed of the same material. In this case, the collector body and window may be of unitary construction, i.e. formed together as a single monolithic entity. Similarly, the collector mirror and the window mirror may be of unitary construction, for instance both deposited together in a mirror formation process.

Alternatively, the collector mirror and the window mirror may be of differing constructions irrespective of whether the collector body and mirror are unitary or not.

The collector body may have a collector aperture passing therethrough from the first surface to the second surface and the window may be disposed to substantially cover the aperture. The window may be disposed inside an aperture in the collector body and passing therethrough from the first side to the second side. The window may for instance be adhered into the aperture or the collector body and the window may, for instance, be of unitary construction. However, the window may merely be disposed to substantially cover an aperture in the collector body, whereby substantially all radiation incident upon the aperture is also incident upon the window. By having a first face on the first side of the collector, it is meant that the first face and the first side are both facing in substantially the same direction (i.e. towards the excitation radiation source), whilst the second face and the second side also face in substantially the same direction (i.e. towards the plasma formation site of the EUV radiation source). Hence, for instance, the window may be located with its first face facing in the same direction as the first side of the collector body, but with the mirror displaced from the aperture in a direction towards the first side or towards the second side of the collector body. There may, for instance, be a gap between the window and the aperture such that a gas flow can pass through the aperture. There may be no aperture at all when the window is of unitary construction with the collector body.

The collector mirror may suitably comprise alternating layers of silicon and molybdenum.

The collector mirror is suitably a concave mirror arranged with substantially circular symmetry about an optical axis passing through the first focus and the collection location. The window is suitably positioned substantially on the optical axis, i.e. such that the optical axis passes through the window. The solid angle subtended by the window mirror at the first focus will typically be less than 50% of the solid angle subtended by the collector mirror, such as less than 30% or less than 15%. The collector mirror is usually an ellipsoidal mirror.

The window may be configured as a lens adapted to focus the excitation radiation onto the plasma formation site at the first focus.

Another aspect of the invention provides a radiation source configured to generate extreme ultraviolet radiation, the radiation source comprising: a chamber; a fuel supply configured to supply a fuel to a plasma formation site within the chamber; an excitation radiation source configured to focus a beam of excitation radiation at the plasma formation site so that a plasma that emits extreme ultraviolet radiation is generated when the beam of excitation radiation impacts the fuel, the collector assembly of the invention having the first surface facing the excitation radiation source and the second surface positioned to collect and reflect extreme ultraviolet radiation emitted by the plasma, wherein the beam of excitation radiation is arranged to pass through the window to the plasma formation site.

Suitable features of the collector assembly of the invention for use in the radiation source of the invention are as detailed hereinbefore.

The excitation radiation source is suitably an infrared laser, such as a Nd:YAG (neodymium-doped yttrium aluminium garnet) laser or a CO₂ laser.

The radiation source suitably comprises a beam stop positioned to substantially block the beam of excitation radiation from passing directly through the radiation source to the collection location.

Another aspect of the invention provides a lithographic apparatus comprising the radiation source or the collector assembly of embodiments of the invention. The lithographic apparatus for patterning a substrate may comprise: a radiation source according to the aspect of the invention detailed hereinbefore, a support constructed and arranged to support a patterning device, the patterning device being configured to pattern extreme ultraviolet radiation from the source directed towards the second focal point, and a projection system constructed and arranged to project the patterned radiation onto the substrate.

A further aspect of the invention provides a device manufacturing method comprising projecting a patterned beam of EUV radiation onto a substrate, wherein the EUV radiation is provided by the radiation source of the invention or collected by the collector assembly of embodiments of the invention. The method suitably comprises: generating extreme ultraviolet radiation at a plasma formation site by directing a laser excitation beam onto a fuel at a plasma formation site through a window in a collector assembly according to the aspect of the invention described hereinbefore, collecting the extreme ultraviolet radiation with the collector assembly and reflecting the extreme ultra-violet radiation towards a second focal point, patterning the extreme ultra-violet radiation reflected towards the second focal point with a patterning device, and projecting the patterned extreme ultraviolet radiation onto a substrate.

According to an aspect of the invention, there is provided a collector assembly for an extreme ultraviolet radiation source comprising an excitation radiation source arranged to generate extreme ultraviolet radiation from a fuel at a plasma formation site. The collector assembly includes a collector body having a first surface and a second surface, opposed to the first surface and provided with a collector mirror thereon. The collector mirror is configured to collect and reflect the extreme ultraviolet radiation from a first focus of the collector mirror at the plasma formation site and to direct the extreme ultraviolet radiation to a collection location. The collector assembly also includes a window transmissive to the excitation radiation and having a first face and an opposed second face. The second face faces towards the first focus. The second face of the window includes a window mirror configured to collect and reflect the extreme ultraviolet radiation from the first focus of the collector mirror at the plasma formation site and to direct the extreme ultraviolet radiation to the collection location. The window mirror is constructed and arranged to be reflective to the extreme ultraviolet radiation and to be transmissive to the excitation radiation.

According to an aspect of the present invention, there is provided a radiation source configured to generate extreme ultraviolet radiation. The radiation source includes a chamber, a fuel supply configured to supply a fuel to a plasma formation site within the chamber, an excitation radiation source configured to focus a beam of excitation radiation at the plasma formation site so that a plasma that emits extreme ultraviolet radiation is generated when the beam of excitation radiation impacts the fuel, and a collector assembly. The collector assembly includes a collector body having a first surface and a second surface, opposed to the first surface and provided with a collector mirror thereon. The collector mirror is configured to collect and reflect the extreme ultraviolet radiation from a first focus of the collector mirror at the plasma formation site and to direct the extreme ultraviolet radiation to a collection location. The collector assembly also includes a window transmissive to the excitation radiation and having a first face and an opposed second face. The second face faces towards the first focus. The second face of the window includes a window mirror configured to collect and reflect the extreme ultraviolet radiation from the first focus of the collector mirror at the plasma formation site and to direct the extreme ultraviolet radiation to the collection location. The window mirror is constructed and arranged to be reflective to the extreme ultraviolet radiation and to be transmissive to the excitation radiation. The beam of excitation radiation is arranged to pass through the window to the plasma formation site.

According to an aspect of the present invention, there is provided a lithographic apparatus that includes a radiation source configured to generate extreme ultraviolet radiation. The radiation source includes a chamber, a fuel supply configured to supply a fuel to a plasma formation site within the chamber, an excitation radiation source configured to focus a beam of excitation radiation at the plasma formation site so that a plasma that emits extreme ultraviolet radiation is generated when the beam of excitation radiation impacts the fuel, and a collector assembly. The collector assembly includes a collector body having a first surface and a second surface, opposed to the first surface and provided with a collector mirror thereon. The collector mirror is configured to collect and reflect the extreme ultraviolet radiation from a first focus of the collector mirror at the plasma formation site and to direct the extreme ultraviolet radiation to a collection location. The collector assembly also includes a window transmissive to the excitation radiation and having a first face and an opposed second lace, the second face facing towards the first locus. The second face of the window includes a window mirror configured to collect and reflect the extreme ultraviolet radiation from the first focus of the collector mirror at the plasma formation site and to direct the extreme ultraviolet radiation to the collection location. The window mirror is constructed and arranged to be reflective to the extreme ultraviolet radiation and to be transmissive to the excitation radiation. The beam of excitation radiation is arranged to pass through the window to the plasma formation site. The lithographic apparatus also includes a support configured to support a patterning device, the patterning device being configured to pattern the collected extreme ultraviolet radiation, and a projection system configured to project the patterned extreme ultraviolet radiation onto a substrate.

The features detailed hereinbefore for the radiation source and collector assembly of the invention are also applicable to the lithographic apparatus and to the device manufacturing method of the invention.

By the term “reflective to EUV radiation” as used herein and applied to a surface or coating, it is meant that at least 30%, or at least 40%, or at least 50% of EUV radiation intensity, of a specified wavelength, normally incident on a surface is reflected.

By the term “transmissive to excitation radiation” applied to a surface, coating or window as used herein, it is meant that at least 80%, or at least 95%, or at least 99% of the excitation radiation intensity, of a specified wavelength, normally incident on the window is transmitted.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 is a more detailed but schematic illustration of the lithographic apparatus of FIG. 1;

FIG. 3 shows a schematic cross-sectional view of a prior art radiation source and collector;

FIG. 4 shows a schematic cross-sectional view of a radiation source and collector assembly according to an embodiment of the invention;

FIG. 5 shows a schematic cross-sectional view of a radiation source and collector assembly according to an embodiment of the invention;

FIG. 6 shows a schematic cross-sectional view of a radiation source and collector assembly according to an embodiment of the invention; and

FIG. 7 shows a schematic cross-sectional view of a radiation source and collector assembly according to an embodiment of the invention.

### DETAILED DESCRIPTION

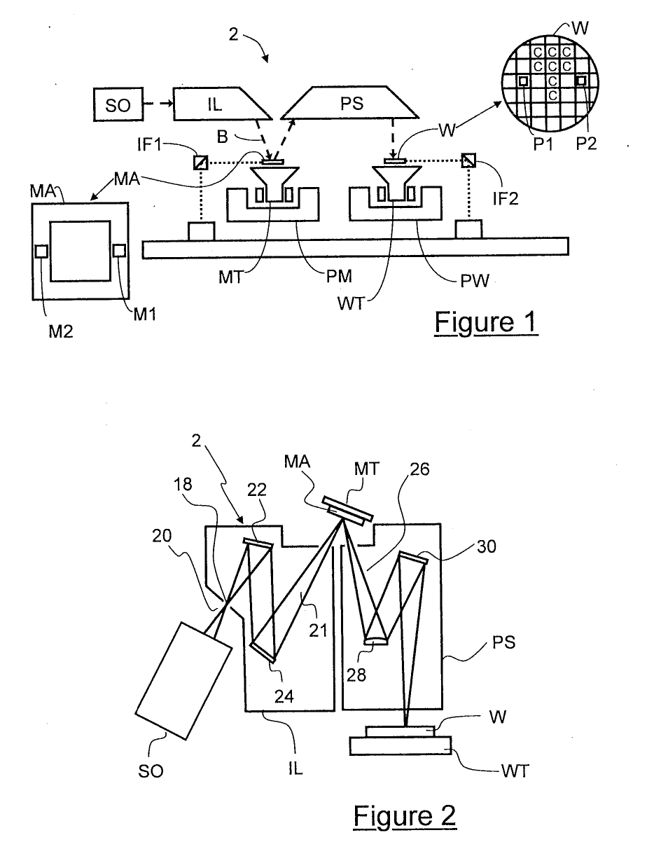

FIG. 1 schematically depicts a lithographic apparatus 2 according to an embodiment of the invention using the radiation source and collector assembly SO of the invention. The apparatus 2 comprises: an illumination system (illuminator) IL configured to condition a radiation beam B (e.g. EUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of the patterning device. It holds the patterning device in a manner that depends on the orientation of the patterning device, the design of the lithographic apparatus 2, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

Examples of patterning devices include masks and programmable mirror arrays. Masks are well known in lithography, and typically, in an EUV radiation (or beyond EUV) lithographic apparatus, would typically be reflective. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system. Usually, in a EUV (or beyond EUV) radiation lithographic apparatus the optical elements will be reflective. However, other types of optical element may be used. The optical elements may be in a vacuum. Any use of the term “projection lens” herein may be considered as synonymous with the more general term “projection system”.

As here depicted, the apparatus 2 is of a reflective type (e.g. employing a reflective mask).

The lithographic apparatus may be of a type having two (dual stage) or more substrate tables (and/or two or more mask tables). In such “multiple-stage” machines the additional tables may be used in parallel, or preparatory steps may be carried out on one or more tables while one or more other tables are being used for exposure.

Referring to FIG. 1, the illuminator IL receives a radiation beam from a radiation emission point (plasma formation site) by means of the radiation source SO including the collector assembly. The source and the lithographic apparatus may be separate entities. In such cases, the radiation source is not considered to form part of the lithographic apparatus and the radiation beam is passed from the radiation source SO to the illuminator IL with the aid of a beam delivery system comprising, for example, suitable directing mirrors and/or a beam expander. In other cases, the source may be an integral part of the lithographic apparatus. The radiation source SO and the illuminator IL, together with the beam delivery system if required, may be referred to as a radiation system.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator and a condenser. The illuminator IL may be used to condition the radiation beam B to have a desired uniformity and intensity distribution in its cross-section.

The radiation beam B is incident on the patterning device (e.g., mask MA), which is held on the support structure (e.g., mask table MT), and is patterned by the patterning device. Having been reflected by the mask MA, the radiation beam B passes through the projection system PS, which focuses the beam onto a target portion C of the substrate W. With the aid of the second positioner PW, and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus 2 could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the plane of the substrate so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2 shows the lithographic apparatus 2 of FIG. 1 in more detail, but still in schematic form, including a collector assembly/radiation source SO according to an embodiment of the invention, an illuminator IL (sometimes referred to as an illumination system), and the projection system PS.

Radiation from a radiation generator (EUV radiation from a plasma formation site) is focussed by the collector assembly at a collection location 18 at an entrance aperture 20 in the illuminator IL. A beam of radiation 21 is reflected in the illuminator IL via first and second reflectors 22, 24 onto a reticle or mask MA positioned on reticle or mask table MT. A patterned beam of radiation 26 is formed which is imaged in projection system PS via first and second reflective elements 28, 30 onto a substrate W held on a substrate table WT.

It will be appreciated that more or fewer elements than shown in FIG. 2 may generally be present in the radiation source SO, illumination system IL, and projection system PS. For instance, in some embodiments the lithographic apparatus 2 may also comprise one or more transmissive or reflective spectral purity filters. More or less reflective elements may be present in a lithographic apparatus.

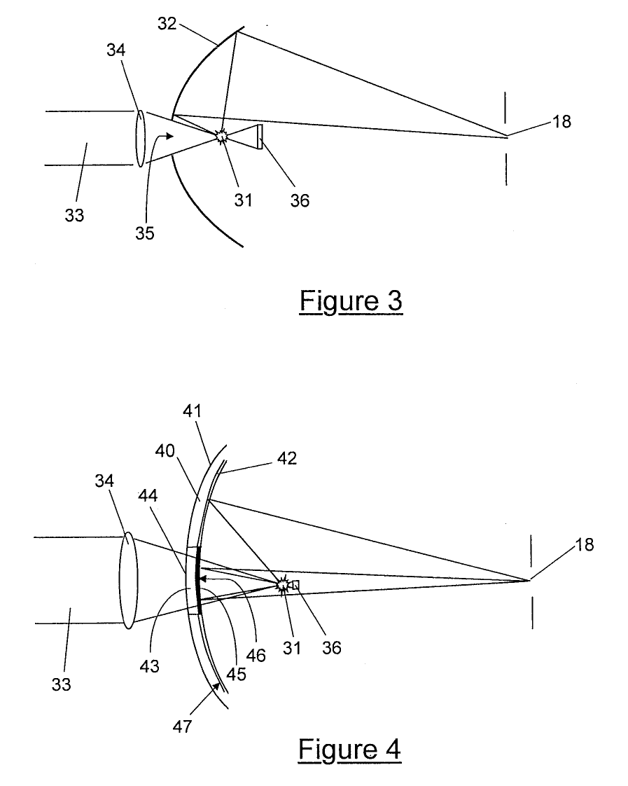

FIG. 3 shows a schematic cross sectional view of a prior art collector and radiation source. The plasma formation site 31 of an LPP generator is located at a first focus of a collector 32 having a mirrored face towards the first focus and plasma formation site 31. The collector 32 forms a concave ellipsoidal mirror. A laser beam 33 from an infrared laser (not shown) is directed onto a lens 34 which focuses the beam as an infrared excitation beam onto the LPP plasma formation site at the first focus 31 through an aperture 35 passing through the body of the collector. EUV radiation generated by the plasma is collected and reflected by the collector 32 towards the collection location 18 at a second focus of the ellipsoidal mirror formed by the collector 32. A beam stop 36 blocks the infrared laser beam and prevents it from passing through to the collector location 18.

EUV radiation falling on the aperture 33 from the plasma formation site at the first focus 31 is lost and not collected at the collection location 18 by the collector 32.

It is desirable that the laser beam is directed onto the plasma formation site through the center of the collector 32 because the EUV generated by the focused beam is most intense in the direction back towards the source of the beam 33. However, EUV radiation falling onto the aperture 35 in the collector 32 is not collected and so is lost leading to non-uniformity in the EUV far-field image and a low EUV collection efficiency.

Turning to FIG. 4, this shows an embodiment of a radiation source according to the invention and having a collector assembly according to an embodiment of the invention.

A collector body 40 has a first surface 41 facing towards the infrared radiation source (not shown) and a second surface 47 carrying a collector mirror 42 Concave towards the plasma formation site 31. A window 43 sits in an aperture in the center of the collector body 40 with a first face 44 facing the infrared source and a second lace 45, carrying a window mirror 46, and facing towards the plasma formation site 31. A laser beam 33 from an infrared laser (not shown) is directed onto a lens 34 which focuses the beam as an infrared excitation beam onto the LPP plasma formation site at the first focus 31 with the beam 33 passing through the window 43 from the first side 44 to the second side 45 and passing through the window mirror 46. A fuel supply FS is configured to supply droplets of fuel to the plasma formation site 31 so that EUV radiation may be generated at the plasma formation site 31 when the laser beam 33 strikes the fuel. EUV radiation generated by the plasma formation site 31 is collected and reflected by the collector mirror 42 towards the collection location 18 at a second locus of the ellipsoidal collector mirror 42. A beam stop 36 blocks the infrared laser beam and prevents it from passing through to the collector location 18. EUV radiation falling on the window mirror 45 is also collected and directed to the collection location 18.

The window mirror 46 suitably comprises a multi-layer stack. The multi-layer stack is configured to substantially reflect extreme ultraviolet radiation and to substantially transmit excitation radiation such as infrared excitation radiation. For example, the excitation radiation that is transmitted can be radiation having a wavelength larger than about 1 μm, particularly larger than about 10 μm, for example about 10.6 μm. The multi-layer stack is transmissive to infrared excitation radiation, whilst configured to provide high EUV reflectivity. Suitable materials for the multi-layer stack include, but are not limited to, ZrN, ZrC, diamond, diamond-like carbon, carbon, silicon and/or Mo₂C. A particularly suitable stack has alternating layers of diamond-like carbon and silicon.

Suitably, the window mirror is configured to transmit more than 50% intensity of incoming excitation radiation, particularly more than 80% and more particularly more than 98%. In particular this applies to excitation radiation having a wavelength of about 10.6 μm, such as from a CO₂ laser, passing through the window at normal incidence, where more than 99% or even more than 99.5% may be transmitted.

The first 44 and/or second 45 faces may be provided with an anti-reflection coating for the excitation radiation as detailed hereinbefore. For instance, a suitable window 43 might have an antireflection coating consisting of a 1770 nm layer of ThF₄ on a 990 nm layer of ZnSe on the first face or the window 43, with the window 43 made of 5 mm thick GaAs. On the second face 45 of the window there may be a 770 nm layer of ThF₄ upon which is deposited a window mirror 46 stack of 40 pairs of alternating layers of 2.9 nm thick diamond like carbon with 4.0 nm thick silicon. The EUV reflectance of such a stack is about 5.0 to 60%, depending upon the carbon density. The infrared transmittance of such a window (for 10.6 μm radiation), including the layers mentioned, is greater than 99.7% for incidence angles from 0° to 25° measured from the optical axis. The collector mirror 42 may be a conventional stack of alternating molybdenum and silicon layers, which may have a higher reflectance for EUV radiation, but is not transmissive to infrared. The EUV reflectivity of a diamond/Si multilayer mirror 46 can be as high as 57.5% (density 3.5 g/cm³), but will typically be around 51% when diamond-like carbon (DLC) is used (density 2.7 g/cm³). For comparison, a Mo/Si multi-layer mirror can have a reflectivity up to 70%. The collector body 40 may be of any suitable material, such as metal or ceramic.

Any suitable method may be used to construct embodiments of the window mirror 45 described herein. For example, it has been shown that diamond-like carbon layers may be grown having a density of up to 2.7 g/cm³, using ion beam sputter deposition.

The collector mirror 42 does not need to be transmissive to the excitation radiation, and a conventional EUV mirror of alternating molybdenum/silicon layers is used to give as high a reflectivity to EUV as possible.

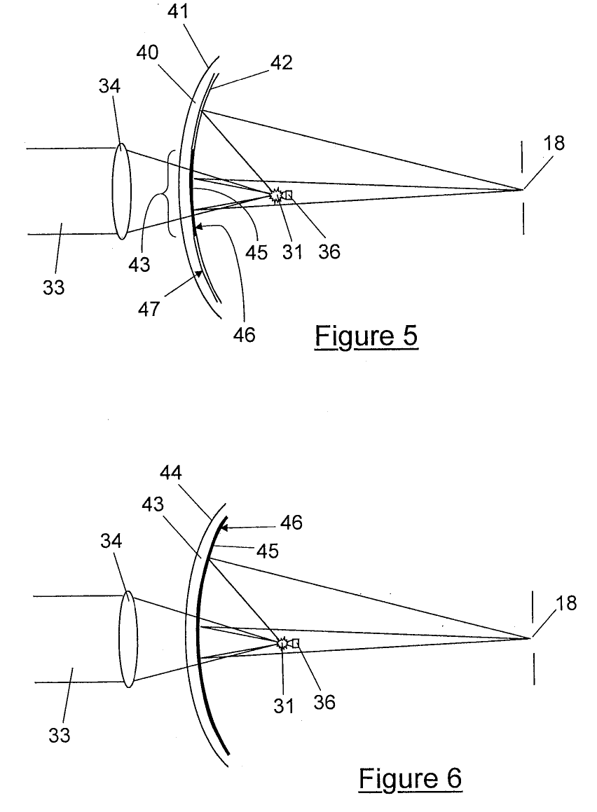

Turning to FIG. 5, this shows an embodiment of a radiation source according to the invention and having a collector assembly according to an embodiment of the invention. This embodiment is similar to the embodiment of FIG. 4, except that where the embodiment of FIG. 4 has a collector body 40 of material non-transmissive to infrared, and includes a window 43 located in an aperture in the collector body 40, the embodiment of FIG. 5 has the body of the collector 40 formed from a material transmissive to infrared, such as gallium arsenide. The window 43 has a mirror stack 46 of DLC/silicon layers, as detailed for the embodiment of FIG. 4, and also has the same antireflective coatings as for the embodiment of FIG. 4, extending over a central region of the collector body 40. The window mirror 46 is deposited on second surface 47 of the collector body, which forms the second face 45 of the window in this embodiment. The remaining part of the second surface 47 holds a conventional EUV mirror 42 of alternating molybdenum/silicon layers.

The embodiment of FIG. 5 may have an advantage of a simpler construction for the collector body 40 and window 43, in that the two components are or unitary construction.

Turning to FIG. 6, this shows an embodiment of a radiation source according to the invention and having a collector assembly according to an embodiment of the invention. This embodiment is as for the embodiment of FIG. 5, except that where the embodiment of FIG. 5 has differing constructions for the window mirror 46 and the collector mirror 42, in the embodiment of FIG. 6, the window mirror 46 extends over the entire second surface of the collector body, labelled 43 as it is also the window body 43 in this embodiment. In other words, the window 43 extends over the whole collector body.

Compared to the embodiments of FIGS. 4 and 5, the embodiment of FIG. 6 has lower collection efficiency because of the construction of the window/collector mirror 46, but it permits a larger numerical aperture to be used for the focusing of the excitation beam 34 onto the plasma formation site 31 and the collector assembly is of simple construction as only a single unitary mirror construction 46 needs to be applied to the second face 45 of the unitary window/collector body 43. A potential advantage of this embodiment is that less infrared will be reflected by the collector and collected in the collection point. This improves the spectral purity of the radiation collected at the collection point.

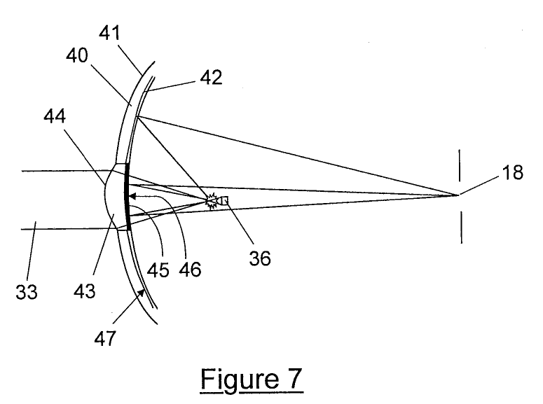

Turning to FIG. 7, this shows an embodiment of a radiation source according to the invention and having a collector assembly according to an embodiment of the invention. This embodiment is as for the embodiment of FIG. 4, except that where a lens 34 is used in the embodiment of FIG. 4 to focus the infrared excitation beam 33 onto the plasma formation site 31 through the window 43, in this embodiment of FIG. 7, the first face 44 of the window 43 is shaped to form a lens adapted to focus the excitation beam 33 onto the plasma formation site 31. Hence the need for a separate lens 34 may be obviated in this embodiment.

Although specific reference may be made in this text to the use of lithographic apparatus in the manufacture of integrated circuits, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc.

Although specific reference may have been made above to the use of embodiments of the invention in the context of optical lithography, it will be appreciated that the invention may be used in other applications, for example imprint lithography, and where the context allows, is not limited to optical lithography.

While specific embodiments of the invention have been described above, it will be appreciated that the invention may be practised otherwise than as described. For instance, in the embodiment of FIG. 7, the window may be of zinc selenide rather than of gallium arsenide. For instance, in any of the embodiments, the excitation beam may not necessarily be directed parallel to the optical axis defined by the first and second foci of the collector mirror, but may be off-axis.

The descriptions above are intended to be illustrative, not limiting. Thus, it will be apparent to one skilled in the art that modifications may be made to the invention as described without-departing from the scope of the claims set out below.

What is claimed is:

1. A collector assembly for an extreme ultraviolet radiation source comprising an excitation radiation source arranged to generate extreme ultraviolet radiation from a fuel at a plasma formation site, the collector assembly comprising:
a collector body having a first surface and a second surface, opposed to the first surface and provided with a collector mirror thereon, the collector mirror configured to collect and reflect said extreme ultraviolet radiation from a first focus of the collector mirror at said plasma formation site and to direct said extreme ultraviolet radiation to a collection location; and
a window transmissive to excitation radiation and having a first face and an opposed second face, the second face facing towards the first focus,
wherein the second face of the window comprises a window mirror configured to collect and reflect said extreme ultraviolet radiation from the first focus of the collector mirror at said plasma formation site and to direct said extreme ultraviolet radiation to the collection location, and wherein the window mirror is constructed and arranged to be reflective to said extreme ultraviolet radiation and to be transmissive to said excitation radiation.

2. The collector assembly of claim 1, wherein said excitation radiation is infra-red radiation.

3. The collector assembly of claim 2, wherein the window is of a material selected from the group consisting of gallium arsenide, zinc selenide, zinc sulfide, germanium and silicon.

4. The collector assembly of claim 1, wherein the first face of the window comprises a first antireflective coating thereon, constructed and arranged to reduce reflection of said excitation radiation on its passage through the first face.

5. The collector assembly of claim 4, wherein the first antireflective coating comprises or is a ThF₄ layer.

6. The collector assembly of claim 5, wherein the first antireflective coating comprises a ZnSe layer between the ThF₄ layer and the first face.

7. The collector assembly of claim 1, wherein the second face of the window comprises a second antireflective coating, constructed and arranged to reduce reflection of said excitation radiation on passage through the second face.

8. The collector assembly of claim 7, wherein the second antireflective coating is located between the second face and the window mirror.

9. The collector assembly of claim 8, wherein the second antireflective coating comprises a ThF₄ layer.

10. The collector assembly of claim 1, wherein the window mirror comprises alternating layers of diamond-like carbon and silicon.

11. The collector assembly of claim 1, wherein the collector body and window are both formed of the same material.

12. The collector assembly of claim 11, wherein the collector body and window are of unitary construction.

13. The collector assembly of claim 1, wherein the collector mirror and the window mirror are of unitary construction.

14. The collector assembly of claim 1, wherein the collector mirror and the window mirror are of differing constructions.

15. The collector assembly of claim 1, wherein the collector body has a collector aperture passing therethrough from the first surface to the second surface and the window is disposed to substantially cover the aperture.

16. The collector assembly of claim 14, wherein the collector mirror comprises alternating layers of silicon and molybdenum.

17. The collector assembly of claim 1, wherein the collector mirror is a concave mirror arranged with substantially circular symmetry about an optical axis passing through the first focus and the collection location.

18. The collector assembly of claim 17, wherein the window is positioned substantially on the optical axis.

19. The collector assembly of claim 1, wherein the collector mirror is an ellipsoidal mirror.

20. The collector assembly of claim 1, wherein the window is configured as a lens adapted to focus said excitation radiation onto said plasma formation site.

21. A radiation source configured to generate extreme ultraviolet radiation, the radiation source comprising:
a chamber;
a fuel supply configured to supply a fuel to a plasma formation site within the chamber;
an excitation radiation source configured to focus a beam of excitation radiation at the plasma formation site so that a plasma that emits extreme ultraviolet radiation is generated when the beam of excitation radiation impacts the fuel; and
a collector assembly comprising
a collector body having a first surface and a second surface, opposed to the first surface and provided with a collector mirror thereon, the collector mirror configured to collect and reflect said extreme ultraviolet radiation from a first focus of the collector mirror at said plasma formation site and to direct said extreme ultraviolet radiation to a collection location; and
a window transmissive to said excitation radiation and having a first face and an opposed second face, the second face facing towards the first focus,
wherein the second face of the window comprises a window mirror configured to collect and reflect said extreme ultraviolet radiation from the first focus of the collector mirror at said plasma formation site and to direct said extreme ultraviolet radiation to the collection location, and wherein the window mirror is constructed and arranged to be reflective to said extreme ultraviolet radiation and to be transmissive to said excitation radiation, and wherein the beam of excitation radiation is arranged to pass through the window to the plasma formation site.

22. The radiation source of claim 21, wherein the excitation radiation source is an infrared laser.

23. The radiation source of claim 21, further comprising a beam stop positioned to substantially block the beam of excitation radiation from passing directly through to the collection location.

24. A lithographic apparatus comprising:
a radiation source configured to generate extreme ultraviolet radiation, the radiation source comprising
a chamber;
a fuel supply configured to supply a fuel to a plasma formation site within the chamber;
an excitation radiation source configured to focus a beam of excitation radiation at the plasma formation site so that a plasma that emits extreme ultraviolet radiation is generated when the beam of excitation radiation impacts the fuel; and
a collector assembly comprising
a collector body having a first surface and a second surface, opposed to the first surface and provided with a collector mirror thereon, the collector mirror configured to collect and reflect said extreme ultraviolet radiation from a first focus of the collector mirror at said plasma formation site and to direct said extreme ultraviolet radiation to a collection location; and
a window transmissive to said excitation radiation and having a first face and an opposed second lace, the second face facing towards the first focus,
wherein the second face of the window comprises a window mirror configured to collect and reflect said extreme ultraviolet radiation from the first focus of the collector mirror at said plasma formation site and to direct said extreme ultraviolet radiation to the collection location, and wherein the window mirror is constructed and arranged to be reflective to said extreme ultraviolet radiation and to be transmissive to said excitation radiation, and wherein the beam of excitation radiation is arranged to pass through the window to the plasma formation site;
a support configured to support a patterning device, the patterning device being configured to pattern the collected extreme ultraviolet radiation; and
a projection system configured to project the patterned extreme ultraviolet radiation onto a substrate.

25. A device manufacturing method comprising:
generating extreme ultraviolet radiation at a plasma formation site by directing a laser excitation beam onto a fuel at a plasma formation site through a window in a collector assembly, the collector assembly comprising
a collector body having a first surface and a second surface, opposed to the first surface and provided with a collector mirror thereon, the collector mirror configured to collect and reflect said extreme ultraviolet radiation from a first focus of the collector mirror at said plasma formation site and to direct said extreme ultraviolet radiation to a collection location; and
a window transmissive to excitation radiation and having a first face and an opposed second face, the second face facing towards the first focus,
wherein the second face of the window comprises a window mirror configured to collect and reflect said extreme ultraviolet radiation from the first locus of the collector mirror at said plasma formation site and to direct said extreme ultraviolet radiation to the collection location, and wherein the window mirror is constructed and arranged to be reflective to said extreme ultraviolet radiation and to be transmissive to said excitation radiation;
collecting the extreme ultraviolet radiation with the collector assembly and reflecting the extreme ultra-violet radiation towards a second focal point;
patterning the extreme ultraviolet radiation reflected towards the second focal point with a patterning device: and
projecting the patterned extreme ultraviolet radiation onto a substrate.
